(19) United States
(12) Patent Application Publication
(10) Pub. No.: US 2004/0177073 A1
(43) Pub. Date: Sep. 9, 2004

(54) Executable application access management system

(76) Inventors: Harry Snyder, Warrington, PA (US); Richard Cullen, Downingtown, PA (US); Bruce E. Arnold JR., Frazer, PA (US)

Correspondence Address: Alexander J. Burke, Intellectual Property Department, 5th Floor, 170 Wood Avenue South, Iselin, NJ, 08830, US

(21) Appl. No.: 10/758,984

(22) Filed: Jan. 16, 2004

Related U.S. Application Data
(60) Provisional application No. 60/440,830, filed on Jan. 17, 2003.

(51) Int. Cl. G06F 7/00

(52) U.S. Cl. 707/9; 713/201

(57) ABSTRACT

A system enables individual organizations of multiple different organizations to manage access of employees to a remotely located application hosted by an application service provider. The system includes a database and a command processor. The database contains data representing multiple user interface images and multiple executable procedures. The multiple user interface images are associated with corresponding multiple organizations. The multiple executable procedures are associated with corresponding multiple user interface images. An executable procedure supports a user of a particular organization in managing access of employees of the particular organization to an application hosted by an application service provider. The command processor employs the database for initiating execution of a particular executable procedure in response to a command initiated using a particular user interface image associated with the particular executable procedure and with the particular organization. The particular executable procedure supports the user in managing access of an employee of the particular organization to an application.

### CROSS-REFERENCE TO RELATED APPLICATIONS

The present application is a non-provisional application of provisional application having serial No. 60/440,830, filed by Harry Snyder, et al. on Jan. 17, 2003.

### FIELD OF THE INVENTION

The present invention generally relates to information systems. More particularly, the present invention relates to an executable application access management system.

### BACKGROUND OF THE INVENTION

Many industries, organizations, and enterprises (each generally described as organizations), such as healthcare enterprises (e.g., hospitals), use an electronic information system to organize and optimize their activities. The activities include any function of the organization such as accounting, record keeping, word processing, document imaging, scheduling, etc. An information system performs the functions using executable applications, conventionally known as software. Users of an information system typically include employees of the organizations. Preferably, an information system employs various security measures to restrict access to the executable applications.

One aspect of an information system is a customer account management (CAM) system. The CAM system typically provides the following functions to system administrators: (1) add new user accounts, (2) add new user application groups, (3) reset user account passwords, (4) disable a user account, (5) enable a user account, (6) modify a user account to support assignment of a user to an application group, and (7) delete a user account.

A first problem related to user accounts is security. Giving hospital administrators access to user accounts in the Active Directory using standard tools and security measures does not ensure privacy and protection of the user accounts from administrators from other hospitals.

A second problem related to user accounts is the uniqueness of logon accounts. Each user account needs to be unique in an Active Directory database. Due to the large number of staff employed by hospitals, certain names may be duplicated amongst hospitals.

One prior method for customer account management involved a system administrator calling a third party, such as an application service provider (ASP), support help desk to perform the account management functions described above. This method is relatively inefficient and insecure for several reasons. One reason is that hospital administrators and users are dependent upon a third party to manage their user accounts. Another reason is that the system administrator typically makes a telephone call to the ASP support help desk to add, change status, or delete a customer user account. Making telephone call takes time, including having the system administrator maybe waiting on hold for a support person to take the call and perform the change. Hence, this method wastes time and possibly increases support staff to perform this method.

In view of the foregoing, would be desirable to provide a CAM system that provides secure access via an intranet or Internet to application user accounts for organizations, such as hospitals. Accordingly, there is a need for executable application access management system that overcomes these and other disadvantages of the prior method.

### SUMMARY OF THE INVENTION

According to one aspect of the present invention, a system enables individual organizations of multiple different organizations to manage access of employees to a remotely located application hosted by an application service provider. The system includes a database and a command processor. The database contains data representing multiple user interface images and multiple executable procedures. The multiple user interface images are associated with corresponding multiple organizations. The multiple executable procedures are associated with corresponding multiple user interface images. An executable procedure supports a user of a particular organization in managing access of employees of the particular organization to an application hosted by an application service provider. The command processor employs the database for initiating execution of a particular executable procedure in response to a command initiated using a particular user interface image associated with the particular executable procedure and with the particular organization. The particular executable procedure supports the user in managing access of an employee of the particular organization to an application.

According to other aspects of the present invention, the system restricts access so that customer account administrators have no access to user accounts assigned to other organizations, preferably by adding a prefix representing the parent organization in order to establish uniqueness. The system permits customers to be self-sufficient to manage their own application user accounts, without requiring intervention by or cooperation with another party. The system provides real time savings for customers, and requires less staff time at the application service provider support help desk to perform account management functions.

### BRIEF DESCRIPTION OF THE DRAWINGS

FIG. 1 illustrates a customer account management (CAM) system, including a user interface device, in accordance with a preferred embodiment of the present invention.

FIG. 2 illustrates a user interface window providing user login access for the user interface device, as shown in FIG. 1, in accordance with a preferred embodiment of the present invention.

FIG. 3 illustrates a user interface window providing an application responsive to user login, as shown in FIG. 2, in accordance with a preferred embodiment of the present invention.

FIG. 4 illustrates a user interface window providing a taskpad responsive to the application, as shown in FIG. 3, in accordance with a preferred embodiment of the present invention.

FIG. 5 illustrates a user interface window providing entry of a user's first name responsive to the taskpad, as shown in FIG. 4, in accordance with a preferred embodiment of the present invention.

FIG. 6 illustrates a user interface window providing entry of a user's last name responsive to the entry of a user's first name, as shown in FIG. 5, in accordance with a preferred embodiment of the present invention.

FIG. 7 illustrates a user interface window providing entry of a user's logon name responsive to the entry of a user's last name, as shown in FIG. 6, in accordance with a preferred embodiment of the present invention.

FIG. 8 illustrates a user interface window providing confirmation of a user's logon name responsive to the entry of a user's logon name, as shown in FIG. 7, in accordance with a preferred embodiment of the present invention.

FIG. 9 illustrates a user interface window providing entry of a group name responsive to the taskpad, as shown in FIG. 4, in accordance with a preferred embodiment of the present invention.

FIG. 10 illustrates a user interface window providing confirmation of a group name responsive to the entry of a group name, as shown in FIG. 9, in accordance with a preferred embodiment of the present invention.

FIG. 11 illustrates a user interface window providing reset of a user's password responsive to the taskpad, as shown in FIG. 4, in accordance with a preferred embodiment of the present invention.

FIG. 12 illustrates a user interface window for adding user accounts to a group responsive to the taskpad, as shown in FIG. 4, in accordance with a preferred embodiment of the present invention.

FIG. 13 illustrates a Microsoft Management Console (MMC) providing administrative tools, in accordance with a preferred embodiment of the present invention.

FIG. 14 illustrates a user interface window for installing a client application on the client device, as shown in FIG. 1, in accordance with a preferred embodiment of the present invention.

### DETAILED DESCRIPTION OF THE PREFERRED EMBODIMENTS

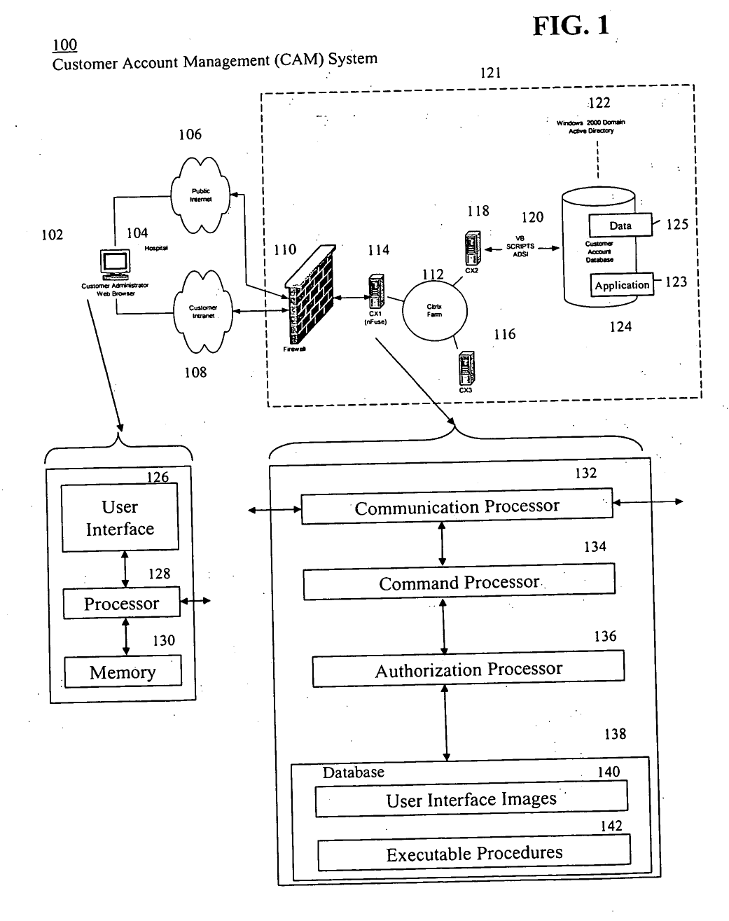

FIG. 1 illustrates a customer account management (CAM) system 100, including a user interface device 102, in accordance with a preferred embodiment of the present invention. The CAM system 100 is intended for use by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a skilled nursing facility, a physical therapy clinic, a chiropractic clinic, and a dental office. In the preferred embodiment of the present invention, the healthcare provider is a hospital 104. Examples of the people being serviced by the healthcare provider include, without limitation, a patient, a resident, and a client.

The system 100 generally includes one or more clients 102, a healthcare provider including a hospital 104, a network including an Internet 106 and an Intranet 108, a firewall 110, a server farm 112 including servers 114, 116, and 118, communication link including visual basic (VB) scripts 120, a Windows ® 1000 Domain Active Directory ®, and a database 124 for storing customer account information. Together, the client 102 and a server, such as server 114, for example, preferably form a client-server computer architecture advantageously permitting the client 102 to be located remotely from the server 114, as is well known in the art. In this case, the firewall 110, the server 114, the VB scripts 120, the Active Directory 122, and the database 124 may be managed by a third party, otherwise called an application service provider (ASP) 121, that is different from the party controlling and/or owning the client 102, as is well known to those skilled in the art of ASPs. Alternatively, the client 102 and the server 114 may form an integral computer architecture requiring the client 102 and the server 114 to be located near one another, as is well known in the art.

The client 102 communicates with the server 114 over the network 106 and/or 108 via one or more communication paths or links. The firewall is a term used to describe hardware and/or software that provide secure communications between the client 102 and the server 114. Each of the client 102 and the server 114 includes communication interfaces for transmitting and/or receiving information over the network 106 and/or 108. The communication paths may be unidirectional or preferably bi-directional, as required or desired. The network 106 and/or 108 may be implemented as a local area network (LAN), such as the intranet 108, or a wide area network (WAN), such as the Internet 106, or a combination thereof. Preferably, the network 106 and/or 108 is a combination of a LAN, formed by an intranet, and a WAN, formed by an Internet.

The client 102 and the server 114 are adapted to communicate over the network 106 and/or 108 using one or more data formats, otherwise called protocols, depending on the type and/or configuration of the various elements in the system 100. Examples of the information system data formats include, without limitation, an RS232 protocol, an Ethernet protocol, a Medical Interface Bus (MIB) compatible protocol, an Internet Protocol (IP) data format, a local area network (LAN) protocol, a wide area network (WAN) protocol, an IEEE bus compatible protocol, and a Health Level Seven (HL7) protocol.

The client 102 and the server 114 are adapted to communicate over the network 106 and/or 108 using a wired or wireless (W/WL) connection. Preferably, the communication paths are formed as a wired connection. In the case of a wired connection, the IP address is preferably assigned to a physical location of the termination point of the wire, otherwise called a jack. The jack is mounted in a fixed location near the location of the various elements of the system 100. In the case of a wireless connection, IP addresses are preferably assigned to the client 102 and/or the server 114, since one or both would be mobile. The wireless connection permits a person using the system 100 to be mobile beyond the distance permitted with the wired connection.

Client

The client 102 further includes a user interface 126, a processor 128, and a memory device 130, and generally are connected to each other, as shown in FIG. 1, to operate in a manner well known to those skilled in the art of client devices. The processor 128 communicates with the user interface 126, the memory 130, and the network 106 and/or 108, in a manner well known to those skilled in the art of client devices. The processor 128 may be implemented in software and/or hardware and operates responsive to a software program stored in the memory 130.

The client 102 is preferably implemented as a personal computer. The personal computer may be fixed or mobile and may be implemented in a variety of forms including, without limitation, a desktop, a laptop, a personal digital assistant (PDA), and a cellular telephone.

The client 102 generally represents healthcare sources, otherwise known as individual systems themselves, which need access to healthcare information, such as patient information, clinical information, orders, and documents. Examples of the healthcare sources include, without limitation, a hospital system, a medical system, and a physician system, a records system, a radiology system, an accounting system, a billing system, and any other system required or desired in a healthcare information system. The hospital system further may include, without limitation, a lab system, a pharmacy system, a financial system, and a nursing system. The medical system represents a healthcare clinic or another hospital system. The physician system represents a physician's office. Typically, the systems in the hospital system are physically located within the same facility or on the same geographic campus. However, the medical system and the physician system are each typically located in a different facility at a different geographic location. Hence, the healthcare sources represent multiple, different healthcare sources that need access to healthcare information, and that may have various physical and geographic locations.

The user interface 126 generally includes an input device and an output device (each not shown), as are well known to those skilled in the art of client devices. The input device permits a user to input information into the client 102 and the output device permits a user to receive information from the client 102. Preferably, the input device is a keyboard, but also may be a touch screen, a microphone with a voice recognition program, for example. Preferably, the output device is a display, but also may be a speaker, for example. The output device provides information to the user responsive to the input device receiving information from the user or responsive to other activity by the client 102. For example, the display presents information to the user, responsive to the user entering information in the client 102 via the keypad, as shown in some of the figures herein.

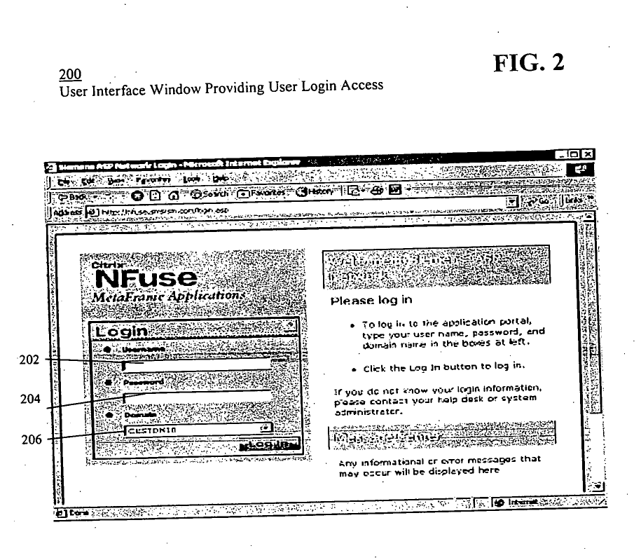

Preferably, the user interface 126 is a graphical user interface (GUI), as shown in FIGS. 2-14, wherein at least portions of the input device and at least portions of the output device are integrated together to provide a user-friendly device. In the preferred embodiment, user interface images, as shown in FIGS. 2-14, are stored in the server 114 and presented to a user, otherwise known as a customer, via the GUI on the client 102. For example, a web browser forms a part of each of the input device and the output device by permitting information to be entered into the web browser and by permitting information to be displayed by the web browser. Many different GUI techniques for inputting data and outputting data, preferably using a browser interface, may be implemented for efficiency and ease of use including, without limitation, selection lists, selection icons, selection indicators, drop down menus, entry boxes, slide bars, search queries, hypertext links, Boolean logic, template fields, natural language, stored predetermined queries, system feedback, and system prompts. The server 114 may also have a user interface (not shown), having an input device and an output device, which operates in the same or different way than the user interface 126 of the client 102.

The memory device 130 may store patient records in the form of a patient database, and stores software appropriate for the client 102. In the preferred embodiment, the database 124 stores client applications 123 and/or data 125, such as the patient records, which are managed by the ASP 121. The patient records, otherwise called patient data files or patient medical record repository, stored in the memory 130 generally include any information related to a patient's health and welfare, and preferably include any information related to a patient's health problems recorded as the orders and/or documents. Examples of patient records related to a patient's health and welfare generally include, without limitation, biographical, financial, clinical, workflow, patient vital signs, and care plan information. Examples of patient records related to a patient's vital signs include, without limitation, a patient's heart rate, respiratory rate, blood oxygen saturation indicator, ventilation related data indicator, and an anatomical electrical activity indicator.

The patient data files stored in the memory 130 and/or database 124 may be represented in a variety of file formats including, without limitation and in any combination, numeric files, text files, graphic files, video files, audio files, and visual files. The graphic files include a graphical trace including, for example, an electrocardiogram (EKG) trace, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

The patient data files stored in the memory 130 and/or database 124 are an organized collection of clinical information concerning one patient's relationship to healthcare provided by a healthcare enterprise (e.g. region, hospital, clinic, or department). Preferably, the healthcare is documented using orders and documents. Hence, the history of the patient's care by the healthcare providers in the healthcare enterprise is represented in the patient data files.

Server

The server 114 further includes a communication processor 132, a command processor 134, an authorization processor 136, and a database 138, wherein the elements of the server 114 are connected to each other, as shown in FIG. 1. The server 114 is preferably implemented as a personal computer or a workstation.

The command processor 134 manages the functions of the server 114. The command processor 134 further manages the communications between the server 114 and the client 102, via the communication processor 132 (otherwise called a communication interface). The authorization processor 136 manages the communications between the command processor 134 and the database 138. Each of the communication processor 132, the command processor 134, the authorization processor 136 may be implemented in software and/or hardware and operates responsive to a software program stored in the database 138. Further, the communication processor 132, the command processor 134, the authorization processor 136 may be formed as separate processors or a single processor.

The database 138, otherwise called a memory device, further includes user interface images 140 and executable procedures 142. The database 138 stores user interface images, as shown in FIGS. 2-14. The database 138 also stores executable procedures 142, otherwise called software, to implement a method managing customer account access, as described herein and as represented in FIGS. 2-14. Preferably, the database 138 that stores the user interface images 140 and the executable procedures 142 is implemented in read only memory (ROM), or other suitable memory unit that runs a predetermined software program while the server 114 is in use. Alternatively or in combination, the database 138 may be implemented in random access memory (RAM), or other suitable memory unit that can be refreshed, cached, or updated while the server 114 is in use. The database 138 and the database 124 may be the same or different databases depending on various network design considerations such as, for example, type, speed, security, location, and size of the memory storage.

In the preferred embodiment of the present invention, the system 100 enables individual organizations 104 of multiple different organizations to manage access of employees to a remotely located application 123 hosted by an application service provider 121. The system 100 includes the database 138 and the command processor 134. The database 138 contains data representing the multiple user interface images 140 and the multiple executable procedures 142. The multiple user interface images 140 are associated with corresponding multiple organizations. The multiple executable procedures 142 are associated with corresponding multiple user interface images 140. An executable procedure 142 supports a user of the particular organization 104 in managing access of employees of the particular organization to the application 123 hosted by the application service provider 121. The command processor 134 employs the database 138 for initiating execution of a particular executable procedure 142 in response to a command initiated using a particular user interface image 140 associated with the particular executable procedure 142 and with the particular organization 104. The particular executable procedure 142 supports the user in managing access of an employee of the particular organization 104 to an application 123.

The authorization processor 136 authorizes access of the user to the particular user interface image 140 and the associated particular executable procedure 142 in response to received identification information of the user. Preferably, the user provides the identification information via the GUI on the client 102. The authorization processor 136 further excludes access of the user and employees of the particular organization 104 to user interface images 140 and executable procedures 142 and data 125 associated with organizations other than the particular organization 104. The authorization processor 136 further excludes access of the user and employees of the particular organization 104 to data 125, associated with organizations other than the particular organization 104, by removing permission of the user and employees of the particular organization 104 to access the data 125, associated with the other organizations, from a directory 122 of permissions used to control data access. Preferably, the directory 122 of permissions includes a Microsoft compatible Active Control List (ACL). Preferably, the authorization processor 136 removes the permission of the user and employees of the particular organization 104 in response to addition of the particular organization 104 as a new organization to the plurality of organizations.

The authorization processor 136 also authorizes access of the employee of the particular organization 104 to the particular user interface image 140 and the associated particular executable procedure 142 in response to received employee identification information. Preferably, the authorization processor 136 uses a combination of an organization specific identifier and received employee identification information in providing an employee access to the application 123 hosted by the application service provider 121 to prevent replication of user identification information between two employees of different organizations of the multiple organizations.

The multiple executable procedures 142 include multiple sets of executable procedures associated with the corresponding multiple user interface images 140. The command processor 134 employs the database 138 to initiate execution of a particular executable procedure 142 in a particular set of executable procedures in response to a command initiated using the particular user interface image 140.

An executable procedure 142 enables the user to perform (a) add an employee, and/or (b) remove an employee, of an organization as a user entitled to access the application 123 hosted by the application service provider 121. Preferably, the executable procedure 142 changes authorization information associated with the added or removed employee. Preferably, the particular executable procedure 142 includes a template procedure customized by the user and/or a technician.

The executable procedure 142 enables the user to amend information used in authorizing a particular employee of an organization 104 to access the application 123 hosted by the application service provider 121.

The executable procedure 142 processor executable instruction in a computer language including one or more of the following: (a) assembly language, (b) machine code, (c) a compiled computer language, (d) an interpreted computer language, (e) a computer language that can be compiled, (f) a script language, and (g) hardware encoded logic.

The command is initiated at a user site, represented as the client 102, via a particular user interface image 140 communicated to the user site 102, and/or the particular executable procedure 142 is communicated to a user site 102 and executed at the user site 102.

From another point of view, the system 100 enables an individual organization 104 of a plurality of different organizations to manage access of employees to one or more remotely located applications 123 hosted by an application service provider 121. The system 100 includes a communication processor 132 and a command processor 134. The communication processor 132 accesses one or more databases 124 containing data representing the multiple user interface images 140 and the multiple executable procedures 142. The user interface images 140 are associated with a corresponding plurality of organizations. The executable procedures 142 are associated with the corresponding multiple user interface images 140. An executable procedure 142 supports a user of a particular organization 104 in managing access of employees of the particular organization 104 to an application 123 hosted by an application service provider 121. The command processor 134 uses the communication processor 132 to initiate execution of a particular executable procedure 142 in response to a command initiated at a user site, represented as the client 102, using a particular user interface image 140 communicated to the user site 102. The particular user interface image 140 is associated with the particular executable procedure 142 and with the particular organization 104. The particular executable procedure 142 supports the user in managing access of an employee of the particular organization 104 to an application 123.

From still another point of view, the system 100 enables individual organizations 104 of multiple different organizations to manage access of employees to one or more remotely located applications 123 hosted by an application service provider 121. The system 100 includes one or more databases 138 and an authorization processor 136. The database 138 containing data representing multiple user interface images 140 associated with a corresponding multiple organizations. The database 138 also contains data representing multiple executable procedures 142 associated with the corresponding multiple user interface images 140. An executable procedure 142 supports a user of a particular organization 104 in managing access of employees of the particular organization 104 to an application 123 hosted by an application service provider 121. The authorization processor 136 authorizes access of the user to a particular user interface image 140 and an associated particular executable procedure 142, associated with the particular organization 104, in response to received identification information of the user, and excludes access of the user and employees of the particular organization 104 to user interface images 140 and executable procedures 142 and data 125 associated with organizations other than the particular organization 104. Preferably, the authorization processor 136 authorizes access of the user in response to a command initiated using the particular user interface image 140.

From yet another point of view, a user interface system 100 enables individual organizations of a plurality of different organizations to manage access of employees to one or more remotely located applications 123 hosted by an application service provider 121. The system 100 includes one or more databases 138 containing data representing multiple sets of user interface images 140 associated with a corresponding multiple organizations. The database 138 also contains data representing multiple executable procedures 142 associated with the corresponding multiple sets of user interface images 140. An executable procedure 142 supports a user of a particular organization 104 in managing access of employees of the particular organization 104 to an application 123 hosted by an application service provider 121. The command processor 134 employs the database 138 to initiate execution of a particular executable procedure 142 in response to a command initiated using a user interface image 140 selected from a set of images 140 associated with a particular organization 104. The particular executable procedure 142 supports the user in managing access of an employee of the particular organization 104 to an application 123.

System

The system 100 provides customer designated administrators access to ASP developed tools for managing customer accounts within an organizational structure. These tools enable customer administrators to manage users and groups for access to application resources on a domain where ASP installed servers and applications. The following functions provided include, without limitation: add a user, add a group, add user(s) to a group, delete user, delete group, remove user(s) from a group, reset user password, and disable\enable user account.

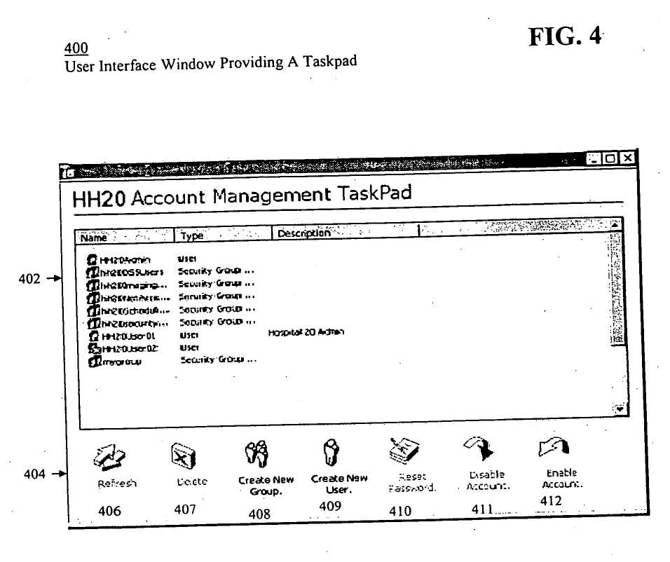

For each hospital or health care organization 104, a customized Microsoft ® Management Console (MMC), called a taskpad 400 (FIG. 4), and visual basic (VB) scripts 120 are created and published to a Citrix ® Metaframe ® server farm 112. For each customer organization 104, a taskpad is developed for managing user objects and groups preferably only within that organization. The taskpad installed on the NFuse/WTS server 114 becomes a published application for each customer administrator group. Global groups created for a customer, herein referred to as “Custdm10” domain name, domain control authentication. The Custdm10 domain name is assigned to the client 102 for the organization 104.

A tool called a snap-in applies application specific object permissions to users and groups. The snap-in tool is also a published application on the NFuse/WTS server 114.

The taskpad 400 provides to the client 102 a graphical user interface (GUI) used to run the VB scripts 120 which perform the actual adds, changes and deletes in the Windows 2000 Active Directory ® 122. One of the Citrix servers 114 in the server farm 112 has an enabled Citrix nFuse ® application to web-enable the taskpad application to make the taskpad application available to a customer administrator using a web browser, such as Microsoft ® Internet Explorer ®, on the client 102. Preferably, the system 100 starts with one Nfuse server 114, for example called “RESAPP01,” and expands to two or more, as needed.

A domain name service (DNS) hostname, for example “useradmin”, is added to the customer DNS zone to permit customer administrators to use the resolution of an address, for example “useradmin.asp.companymedical.com”, to access the nFuse logon screen across the intranet 108 or the Internet 106, via the client 102. When the customer administrator logs in using a domain account, for example “Custdm10,” the appropriate taskpad for that hospital or health care organization 104 is presented to the user at the client 102.

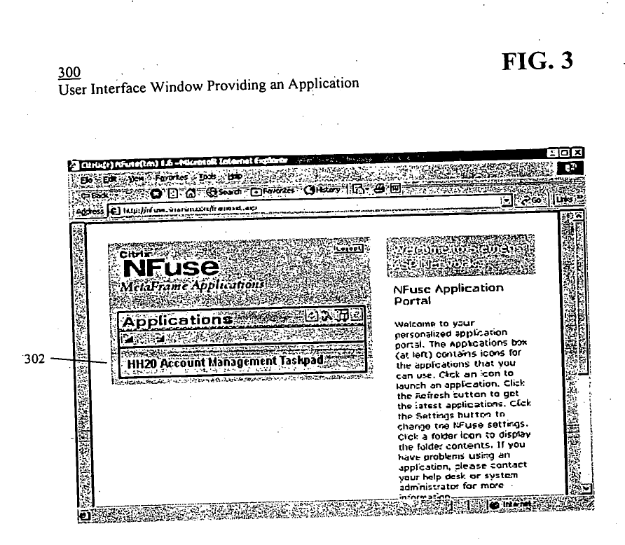

Using a Citrix ® Nfuse ® MetaFrame application 300 (FIG. 3) to publish many taskpad applications (e.g., one for each hospital) effectively manages and restricts access to customer accounts within the system 100. The VB scripts 120, which operate on the Active Directory 122, further ensure secure access and enforce a user naming standard HHRR prefix ensuring uniqueness of duplicate names amongst many hospitals. For example, “Joe Smith” at Hospital A can be resolved and distinguished from “Joe Smith” at Hospital B.

When a system administrator creates a logon name for a user account for the first time, the system administrator adds a hospital code prefix to the logon name. The prefix represents a hospital region code associated with a particular hospital or health care organization. The prefix ensures uniqueness of a logon name because Microsoft ® Active Directory ® domain accounts cannot have duplicate logon names. For example, Joe Smith from hospital XYZ (Code=XYZ0) could have a logon account of XYZ0jsmith, and Joe Smith from hospital ABC (Code=ABC0) could have a logon account ABC0jsmith.

The system 100 is readily applicable to non-health care information systems business. The system 100 may be used to manage customer accounts for any type of business that has a need to manage accounts for multiple customer organizations organized into a Windows 2000 Active Directory Domain (database), for example.

FIGS. 2-14 provide a description of the user interface windows presented to the user at the client 102, and a description of the VB scripts 120 for the customer account management (CAM) system 100.

System Security

The security scheme involved in excluding access of a user and employees of a particular organization 104 to user interface images 140 and executable procedures 142 and data 125 associated with organizations other than the particular organization include the following: (1) the firewall security, (2) the NFuse web enablement, (3) Citrix published application (i.e., the taskpad), (4) applied Microsoft ® Active Directory ® (AD) security, (5) an AD schema change, and (6) the VB scripts 120 which are associated with the particular organization 104.

Further, several layers of security ensure privacy of user accounts. The published taskpad for each organization is restricted to authorized customer administrators via Windows 2000 Active Directory permissions. Organization security is set when a new customer organization is created to deny access to any domain user or customer administrator.

Further, Read, Write, and Create authority is explicitly given to those customer administrators from a specific organization 104 that was granted permission to manage the user accounts within that organization 104. These customer administrators have no explicit access to any other customer organization.

Still further, a taskpad is created using a “new window from here.” The taskpad is created is then locked keeping the customer from navigating outside of their organization structure.

The Microsoft Active Directory Schema is operated in conjunction with a procedure such that, when any new organization is created, the group “Authenticated Users” by default, is no longer given permission to “Read” through this new organization. This further ensures the security of one customer's data from other customers.

FIG. 2 illustrates a user interface window 200 providing user login access for the user interface device 126, as shown in FIG. 1, in accordance with a preferred embodiment of the present invention. Preferably, customer account administrators (typically employed by the healthcare organization 104) enter a universal resource locator (URL), for example http://useradmin.asp.companymedical.com, into an address window of a web browser at the client 102 to access the customer login window 200 for the Citrix Nfuse MetaFrame Application. Under the login section, the administrator enters appropriate information into a username window 202, a password window 204, and a domain name window 206. A network administrator predefines specific firewall settings for the firewall 110, shown in FIG. 1, to permit access from a specific hospital or other health care organization 104. A DNS server 114 resolves the URL name from the intranet 108 or Internet 106. Preferably, the firewall settings are specific to an Internet Protocol (IP) range for the customer network. For example, a firewall is opened for Hospital XYZ for IP addresses 10.10.10.1 through 10.10.10.99 for specific ports (e.g., ports 80 and 1494).

FIG. 3 illustrates a user interface window 300 providing an application responsive to user login 200, as shown in FIG. 2, in accordance with a preferred embodiment of the present invention. After the customer account administrator logs in from the hospital 104, the user interface 126 presents the applications page window 300. The window 300 is the web page that provides administrator access to the specific customized taskpad for that particular hospital 104. Preferably, administrators access the specific customized taskpad by selecting the name for the specific taskpad application, for example “HH20 Account Management Taskpad” 302, under the “Applications” section of the window 300.

FIG. 4 illustrates a user interface window 400 providing a taskpad responsive to the application 302, as shown in FIG. 3, in accordance with a preferred embodiment of the present invention. The window 400 provides an example of a taskpad that the customer account administrator uses to manage the hospital user accounts. This window consists of a list window 402 of current existing users and application groups, associated with that hospital 104 and described by “Name,” “Type,” and “Description,” and a grouping of functional icons 404 at the bottom of the window 400. The functional icons 404 shown include, for example, “Refresh 406,” “Delete 407,” “Create New Group 408,” “Create New Password 409,” “Reset Password 410,” “Disable Account 411,” and “Enable Account 412.” A description follows for each of the functions represented by the icons 404 available from the taskpad window 400.

Preferably, the taskpad is a customized graphical view of Microsoft ® Management Console (MMC) that is a standard feature of Windows ® 2000 server. The taskpad used for customer account management (CAM) links to ASP-developed VB scripts 120 specifically designed for each hospital entity 104 to manage application user accounts. These VB scripts 120 provide the function and security for hospital administrators to self-manage the customer accounts.

Create New User

The following five steps describe a method for an administrator to create a new user.

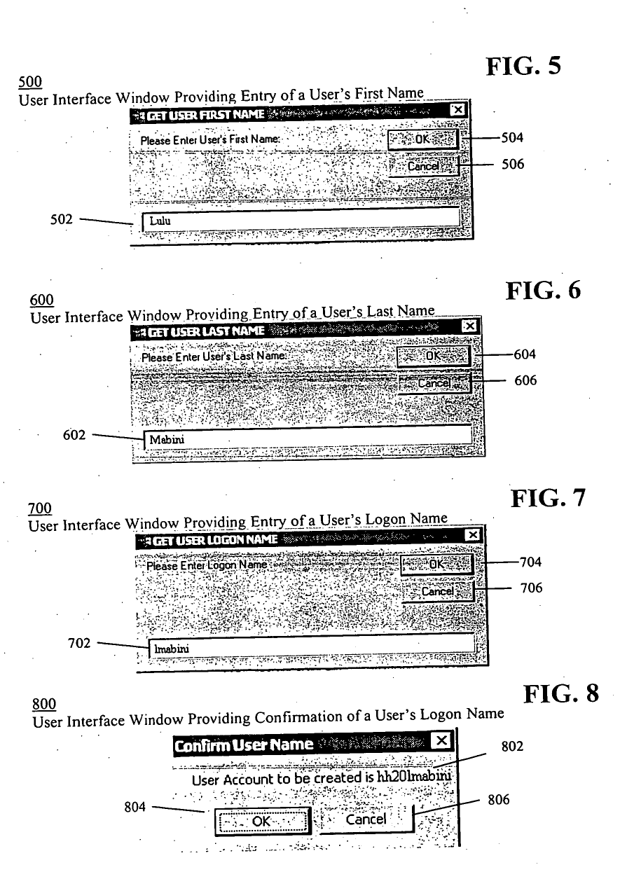

Step 1: The administrator clicks the “Create New User” icon 409 in the taskpad window 400 to access the FIG. 5. FIG. 5 illustrates a user interface window 500 providing entry of a user's first name responsive to the taskpad 400, as shown in FIG. 4, in accordance with a preferred embodiment of the present invention. The window 500 includes a window 502, an “OK” box 504, and a “Cancel” box 506. The administrator is permitted to enter a user's first name, for example “Lulu,” in the window 502. The administrator approves and disapproves the user's first name entered into the window 502 by selecting the “OK” box 504 and the “Cancel” box 506, respectively.

Step 2: The administrator enters the user's first name in window 502 and selects the “OK” box 504, to access FIG. 6. FIG. 6 illustrates a user interface window 600 providing entry of a user's last name responsive to the entry of a user's first name, as shown in FIG. 5, in accordance with a preferred embodiment of the present invention. The window 600 includes a window 602, an “OK” box 604, and a “Cancel” box 606. The administrator is permitted to enter a user's last name, for example “Mabini,” in the window 602. The administrator approves and disapproves the user's last name entered into the window 602 by selecting the “OK” box 604 and the “Cancel” box 606, respectively.

Step 3: The administrator enters the user's last name in window 602 and selects the “OK” box 604, to access FIG. 7. FIG. 7 illustrates a user interface window 700 providing entry of a user's logon name responsive to the entry of a user's last name, as shown in FIG. 6, in accordance with a preferred embodiment of the present invention. The window 700 includes a window 702, an “OK” box 704, and a “Cancel” box 706. The administrator is permitted to enter a user's logon name, for example “lmabini,” in the window 702. The administrator approves and disapproves the user's logon name entered into the window 702 by selecting the “OK” box 704 and the “Cancel” box 706, respectively.

Step 4: The administrator enters the user's logon name in window 702 and selects the “OK” box 704, to access FIG. 8. FIG. 8 illustrates a user interface window 800 providing confirmation of a user's logon name responsive to the entry of a user's logon name, as shown in FIG. 7, in accordance with a preferred embodiment of the present invention. The window 800 includes the received user's logon name 802, for example “hh20lmabini,” an “OK” box 804, and a “Cancel” box 806. The administrator approves and disapproves the user's logon name 802 presented the window 800 by selecting the “OK” box 804 and the “Cancel” box 806, respectively.

Step 5: The administrator confirms the user's logon name 802 presented in the window 800 by selecting the “OK” box 804. Responsive to the administrator selecting the “OK” box 804, the system 100 adds the site's hospital and region code (HHRR), for example “hh20,” to the user logon name, for example “Imabini.”

Preferably, the system 100 automatically assigns a password to each new user account created by the administrator. The user's password should be changed at the next logon. Preferably, the passwords should be at least eight characters and include one uppercase letter and one numeric character (e.g., Password1).

Adding a New Group

The following three steps describe a method for an administrator to create a new group.

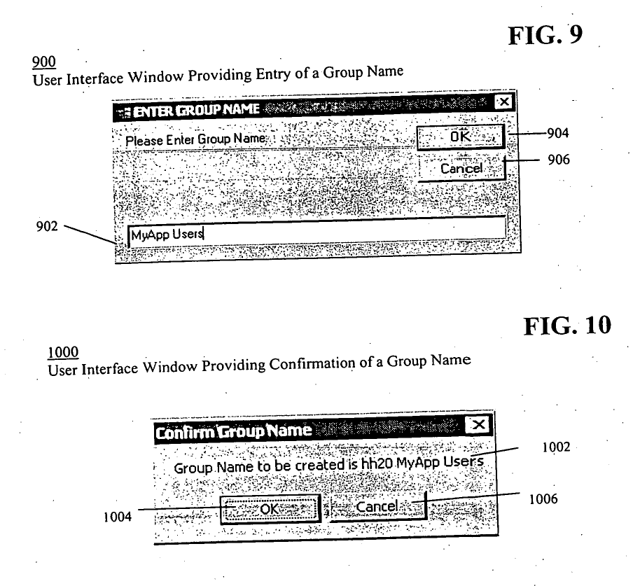

Step 1: The administrator clicks the “Create New Group” icon 408 in the taskpad window 400 to access the FIG. 9. FIG. 9 illustrates a user interface window 900 providing entry of a group name responsive to the taskpad 400, as shown in FIG. 4, in accordance with a preferred embodiment of the present invention.

Step 2: The administrator enters the group name in window 902 and selects the “OK” box 904, to access FIG. 10. FIG. 10 illustrates a user interface window 1000 providing confirmation of a group name responsive to the entry of a group name, as shown in FIG. 9, in accordance with a preferred embodiment of the present invention. The window 1000 includes the received group name 1002, for example “hh20MyApp Users,” an “OK” box 1004, and a “Cancel” box 1006. The administrator approves and disapproves the group name 1002 presented in the window 1000 by selecting the “OK” box 1004 and the “Cancel” box 1006, respectively.

Step 3: The administrator confirms the group name 1002 presented in the window 1000 by selecting the “OK” box 1004. Responsive to the administrator selecting the “OK” box 1004, the system 100 adds the site's hospital and region code (HHRR), for example “hh20,” preferably followed by a space to the group name, for example “hh20 MyApp Users.”

Resetting a Password

The following five steps describe a method for an administrator to reset a password.

Step 1: The administrator accesses the taskpad 400.

Step 2: The administrator selects the user in window 402 that needs the password to be reset.

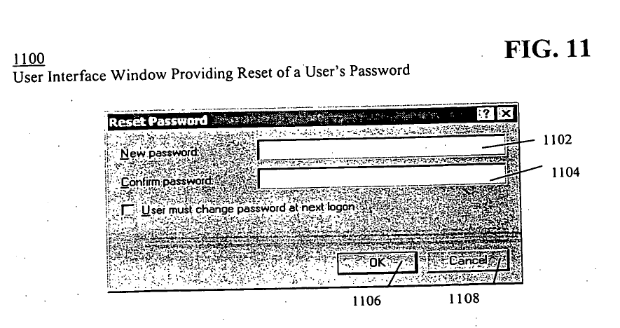

Step 3: The administrator selects the “Reset Password” icon 410 in the taskpad window 400 to access the FIG. 1. FIG. 11 illustrates a user interface window 1100 providing reset of a user's password responsive to the taskpad 400, as shown in FIG. 4, in accordance with a preferred embodiment of the present invention. The window 1100 includes a new password window 1102, a confirm password window 1104, an “OK” box 1106, and a “Cancel” box 1108.

Step 4: The administrator is permitted to enter a password in the new password window 1102. In this example, the user enters the same password again in the confirm password window 1104 to confirm that the administrator entered the correct new password.

Step 5: The administrator approves and disapproves the new password entered into the window 1102 by selecting the “OK” box 1106 and the “Cancel” box 1108, respectively.

Disabling a User Account

The following four steps describe a method for an administrator to disable a user account.

Step 1: The administrator accesses the taskpad 400.

Step 2: The administrator selects the user in window 402 that needs to be disabled.

Step 3: The administrator selects the “Disable Account” icon 411 in the taskpad window 400.

Step 4: A confirmation window (not shown), preferably having the name of the account to be disabled, an “OK” box, and a “Cancel” box, appears (i.e., pops up) responsive to the administrator selecting the “Disable Account” icon 411. The administrator approves and disapproves the disabled account presented in the window by selecting the “OK” box and the “Cancel” box, respectively.

Enabling a Disabled User Account

The following four steps describe a method for an administrator to enable a user account.

Step 1: The administrator accesses the taskpad 400.

Step 2: The administrator selects the user in window 402 that needs to be enabled.

Step 3: The administrator selects the “Enable Account” icon 412 in the taskpad window 400.

Step 4: A confirmation window (not shown), preferably having the name of the account to be enabled, an “OK” box, and a “Cancel” box, appears (i.e., pops up) responsive to the administrator selecting the “Enable Account” icon 412. The administrator approves and disapproves the enabled account presented in the window by selecting the “OK” box and the “Cancel” box, respectively.

Adding User Accounts to a Group

The following five steps describe a method for an administrator to add user accounts to a group.

Step 1: The administrator accesses the taskpad 400.

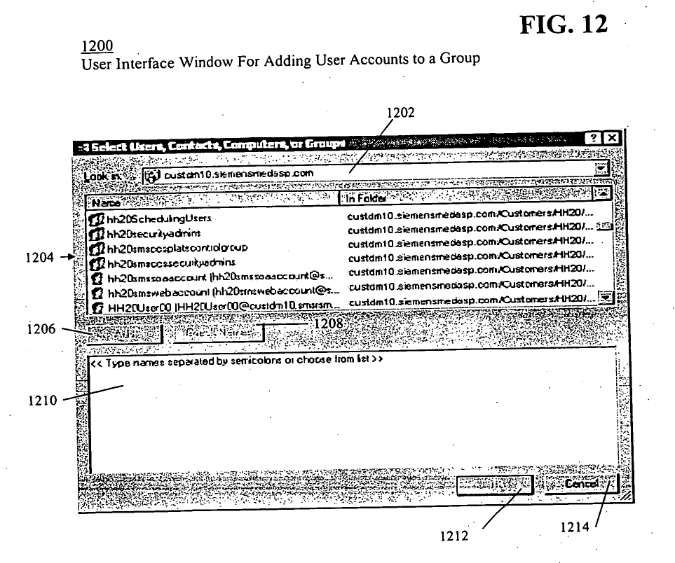

Step 2: The administrator selects, for example by double clicking, the user in window 402 that needs to be added to a group. The administrator selects a “Members of” tab (not shown) to access FIG. 12. FIG. 12 illustrates a user interface window 1200 for adding user accounts to a group responsive to the taskpad 400, as shown in FIG. 4, in accordance with a preferred embodiment of the present invention. The window 1200 includes a look in window 1202, a “Select Matching Items” window 1204 listing group names and corresponding folders, an “Add” box 1206, a “Check Names” box 1208, a group name input window 1210, an “OK” box 1212, and a “Cancel” box 1214.

Step 3: The administrator selects a group name from the window 1204.

Step 4: The administrator selects the “Add” box 1206 to cause the system 100 to add the user to the selected group.

Step 5: The administrator selects the. “OK” box 1212, when the administrator is finished adding users to the group.

Adding Multiple User Accounts to a Group At the Same Time For greater efficiency, the following eight steps describe a method for an administrator to add multiple users to a group at the same time.

Step 1: The administrator selects, for example by double clicking, the group that they want to add the users to. The selected group's four Properties tabs appear in a new window (not shown).

Step 2: The administrator selects the “Members” tab (not shown).

Step 3: The administrator selects the “Add” box that is in the lower left-hand corner of the new window.

Step 4: The administrator selects types in a site's four-character HHRR code in the window 1200 to retrieve a listing of the users and groups for a particular facility in the “Select Matching Items” window 1204.

Step 5: The administrator holds down the Control key on their keyboard and selects the users that they wish to add to the group.

Step 6: The administrator selects the “OK” box 1212, after they are done selecting users. The administrator then sees the selected users in the Members window (not shown) of the selected group's Properties tabs (not shown).

Step 7: The administrator selects the “Apply” box in the Members window (not shown).

Step 8: The administrator selects the “OK” box in the Members window (not shown).

Deleting a User Account or Group

The following four steps describe a method for an administrator to delete user accounts to a group.

Step 1: The administrator accesses the taskpad 400.

Step 2: The administrator selects the user name or group from the window 402 in taskpad 400 (FIG. 4) that the administrator wants to delete.

Step 3: The administrator selects the “Delete” 407 icon 407 in taskpad 400 in FIG. 4.

Step 4: A confirmation window (not shown), preferably having the name of the account to be deleted, an “OK” (or “Yes”) box, and a “Cancel” box, appears (i.e., pops up) responsive to the administrator selecting the “Delete” icon 407. The administrator approves and disapproves the deleted account presented in the window by selecting the “OK” box and the “Cancel” box, respectively.

Refreshing the Taskpad Window

The administrator selects the Refresh 406 icon to update the list of users and groups displayed in the list window 402 of the taskpad 400 in FIG. 4. The administrator may need to refresh the display of users and groups shown in the list window 402, if more than one administrator is making changes using the taskpad 400.

Preparing VB Scripts 120 for Taskpad Use

There are two template scripts on the “RESAPP02” server 114 in an “O:\scripts” folder. The two template scripts are “createusertemplate.vbs” and “creategrouptemplate.vbs.” They are read-only template scripts. Each of the two templates scripts are preferably edited and saved using a different name for each hospital organization 104 taskpad 400 (FIG. 4). For example, hospital hh20 will have two customized scripts: (1) “createuserhh20.vbs” and (2) “creategrouphh20.vbs.”

Create User Script

The following description describes how to create custom scripts for a new hospital organizational, named for example “hh20 Hospital.”

On the “RESAPP02” server 114, open “O:\scripts\createusertemplate.vbs” in notepad. The script appears as follows.

REM CreateUserTemplate.vbs

REM Version 1.0

REM Author—Harry Snyder ASP Technology

REM Last Update—Apr. 25, 2002

REM THIS TEMPLATE IS USED TO CREATE A CUSTOM SCRIPT FOR A HOSPITAL ADMIN TO ADD

REM NEW USERS TO A CUSTOMER OU WITHIN CUSTDM10 ACTIVE DIRECTORY.

REM

REM MODIFY THE FOLLOWING (1,2,3,4) VARS TO CUSTOMIZE THIS SCRIPT.

REM (1) HOSPITAL REGION CODE

hhrr=“hhrr”

REM (2) HOSPITAL OU NAME

ouname=“hhrr Hospital”

REM (3) HOSPITAL USERS OU NAME

userouname=“hhrr Hospital Users”

REM (4) USER TEMPLATE NAME

groupname=“hhrr_user_template”

REM

REM ALLOCATE GLOBAL VARS HERE

Dim adspath,grouppath,userpath

Dim firstname,lastname,username,userfullname,hhrrusername

Dim group,logonname,newuser,rc,targetou,usr

REM SCRIPT BEGINS HERE

In the script above, there are four variables (e.g., hhrr, ounarne, userouname, and groupname) to be edited for the hh20 Hospital.

After editing the variables for the hh20 Hospital, the variables will look like the following:

REM CreateUserTemplate.vbs

REM Version 1.0

REM Author—Harry Snyder ASP Technology

REM Last Update—Apr. 25, 2002

REM THIS TEMPLATE IS USED TO CREATE A CUSTOM SCRIPT FOR A HOSPITAL

ADMIN TO ADD

REM NEW USERS TO A CUSTOMER OU WITHIN CUSTDM10 ACTIVE DIRECTORY.

REM

REM MODIFY THE FOLLOWING (1,2,3,4) VARS TO CUSTOMIZE THIS SCRIPT.

REM (1) HOSPITAL REGION CODE

hhrr=“hh20”

REM (2) HOSPITAL OU NAME

ouname=“hh20 Hospital”

REM (3) HOSPITAL USERS OU NAME

userouname=“hh20 Hospital Users”

REM (4) USER TEMPLATE NAME

groupname=“hh20_user_template”

REM

REM ALLOCATE GLOBAL VARS HERE

Dim adspath,grouppath,userpath

Dim firstname,lastname,username,userfullname,hhrrusername

Dim group,logonname,newuser,rc,targetou,usr

REM SCRIPT BEGINS HERE

This script is saved as “O:\scripts\createuserhh20.vbs.”

Create Group Script

Next, open “O:\scripts\creategrouptemplate.vbs” on the “RESAPP02” server 114 and edit the three variables (e.g., hhrr, ouname, and userouname) for the hh20 Hospital to produce the following script.

REM CreateGroupTemplate.vbs

REM Version 1.0

REM Author—Harry Snyder ASP Technology

REM Last Update—Apr. 30, 2002

REM THIS TEMPLATE IS USED TO CREATE A CUSTOM SCRIPT TO CREATE A

NEW GLOBAL GROUP IN

REM CUSTOMERS OU OF ACTIVE DIRECTORY.

REM

REM MODIFY THE FOLLOWING (1,2,3,4) VARS TO CUSTOMIZE THIS SCRIPT.

REM (1) HOSPITAL REGION CODE

hhrr=“hh20”

REM (2) HOSPITAL OU NAME

ouname=“hh20”

REM (3) HOSPITAL USERS OU NAME

userouname=“hh20 Users”

REM

REM ALLOCATE GLOBAL VARS HERE

Dim groupname

Dim hhrrgroupname

Dim rc

Dim group

REM

Save this file as “O:\scripts\creategrouphh20.vbs.”

After creating the two scripts (createuserhh20.vbs and creategrouphh20.vbs) the two scripts are integrated into the taskpad 400. First, taskpad creation is initiated using “file,” “run MMC” (on the RESAPP02 server 114). Add “Active Directory Users and Computers,” set “New Window” from here on hh20 users, and choose “Taskpad View”. Choose “Shell” command as the command type.

The following steps create a user and group.

Step 1: Create User script.

Step 2: Add the path for the Create User script. This is o:\scripts\createuserhh20.vbs. Everything else is default.

Step 3: Add the task name: Create New User.

Step 4: Select a task icon.

Step 5: Add the Create Group script.

Step 6: Select, run this wizard again to re-run the wizard for Create Group function. Again, choose “Shell” command as command type.

Step 7: Enter the path name for the Create Group script as o:\scripts\creategrouphh20.vbs.

Step 8: Add Task Name Create New Group.

Step 9: Select a task icon for this Create Group task.

Step 10: Continue with the taskpad wizard to add additional functions such as reset password, disable account, etc.

Custdm10 (Customer) Organizational Structure

Below is the organizational structure for a hospital 104 in the Active Directory 122 on the customer domain called “CUSTDM10.” Preferably, there is one organizational structure for each hospital. An ASP NT systems administration team permits access for new organizations when a new hospital HHRR is installed in the ASP production environment. In the structure presented below, a line followed by a “D” represents a definition, and a line followed by a “M” represents a membership. These representations are for explanation purposes only and do not form a formal part of the structure.

CUSTDM10.COMPANYMEDASP.COM

−Admin Exclusions (OU)

All Client Admins (group) “D”

hh00 Admistration (group) “M”

* “M”

hhnn Administration (group) “M”

−BuiltIn (container)

Account Operators (group)
Server Operators (group)
Administrators (group)

−Computers (container)
+Customers(OU)

−hhrr(OU)

hhrr Platform Services (OU)

hhrr SmsCcsSecurityAdmins(role group) “D”

hhrrSmsSoaAccount (service account) “M”
hhrrSmsWebAccount (service account) “M”

hhrr SmsCcsPlatsControlGroup (control group) “D”

hhrrSmsCcsSecurityAdmins(role group)

hhrr Users (OU)

hhrrUser01 (administrator) “D”
hhrrUser02 (user) “D”
hhrr Administration (group) “D”

hhrrUser01 “M”

hhrr Document Management (group) “D”
hhrr NetAccessUsers (group) “D”
hhrr SchedulingUsers (group)
hhrr DSSUsers (group) “D”

−Orphan Users (OU)

(container for old infrastructure user accounts) “D”

−Domain Controllers (OU)

CUSTDC12 “D”
CUSTDC13 “D”

−ForeignSecurityPrincipals (container)
+NT System Accounts(OU)

−Users(OU)
Administrator “D”
Domain Admins (group) “D”
Etc “D”

−Service Accounts (OU)

Platform Services (OU)

SmsSoaAccount (user) -> service account for ICO “D”
SmsWebAccount (user) -> service account for ICO “D”
hhrrSmsSoaAccount (user) -> service account for RCO “D”
hhrrSmsWebAccount (user) -> service account for RCO
“D”
SmsCcsPlatsControlGroup (control GROUP) “D”

SmsCcsSecurityAdmins (role GROUP) “M”

SmsCcsSecurityAdmins (role GROUP) “D”

SmsSoaAccount (user) “M”
SmsWebAccount (user) “M”

Document Management (OU)
Net Access (OU)
DSS (OU)
Scheduling (OU)

−Vendors(OU)

Metafile(OU) “D”
RPM(OU) “D”

−SMS Information (container)

Resource Inventory (container) “D”

SmsCcsKeySeedContainer

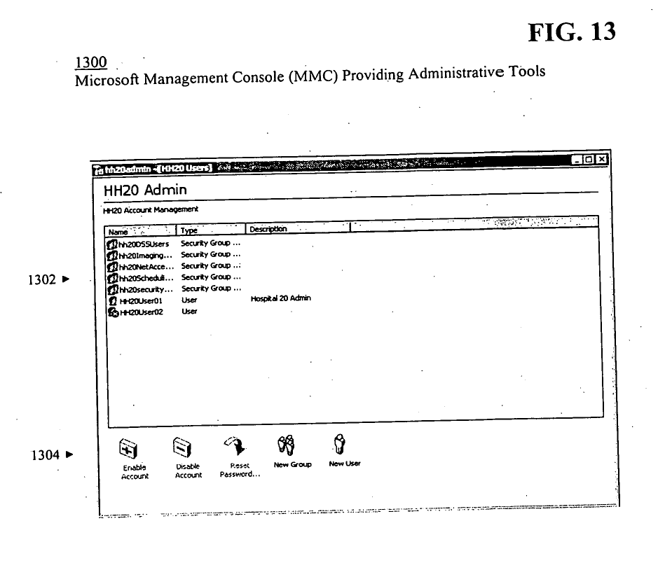

FIG. 13 illustrates a Microsoft Management Console (MMC) 1300 providing administrative tools, in accordance with a preferred embodiment of the present invention. Microsoft Management console (MMC) 1300 enables system administrators to create special tools to delegate specific administrative tasks to users or groups. Microsoft provides standard tools with the operating system that perform everyday administrative tasks that users need to accomplish. Preferably, the Active Directory Users and Computers snap-in tool is used to manage users and groups within the active directory organization structure on the “CUSTDM10” customer domain.

TaskPad View

MMC's TaskPad View displays shortcuts for common tasks directly on the console and can be used to restrict the view of Active Directory to a single window and a single organization (such as a hhrr users), and to prevent navigation to other parts of Active Directory. Icons are created to provide these shortcuts. FIG. 13 illustrates a sample TaskPad View for managing HH20 Users accounts in the “CUSTDM10” customer domain Active Directory tree.

Creating a Console

The most common way to use an MMC 1300 is to simply start a predefined console file from the Start menu or desktop. Preferably, the ASP 121 provides this to their customer administrators to create a customized MMC 1300.

On the Start Menu, click Run, type MMC, and the click OK. MMC opens with an empty console. The empty console has no management functionality until you add some snap-in tools.

Next, click on Console. On the Console Menu, click on Add/Remove Snap-In. The Add/Remove Snap-In dialog box opens. This lets one enable extensions and configure which snap-ins are in the console file. Select Active Directory Users and Computers. The Active Directory Users and Computers tool is now open for the “Custdm10” customer domain.

Note that if the user is a support person or installer using a predefined domain name account, for example “RESDM50” account, then Active Directory Users and Computers opens with a focus on “RESDM50.” One may change the focus by clicking on Active Directory Users and Computers and then selecting the domain custdm10.companymedasp.com.

Drill down on custdm10.companymedasp.com and set the focus on the hospital orgainization. Right click and select New Window. Now click Save As from the console pull down menu and give the new MMC a name such as “hhrradmin.msc.”

Creating a Taskpad

From the Window menu, select new window. Close the other window and maximize the remaining window. In the left pane, click on hospital orgainization and select New Taskpad. Go through the wizard accepting defaults. Verify the checkbox on the last page is checked so that the Task Creation wizard can start automatically. Click next and accept the defaults for the rest of the screens. Click Finish. From the view menu, click Customize and click each of the options except the Description bar to hide each type of toolbar. From the Console menu, select Options. Change the console mode by selecting User Mode-Limited Access, Single Window from the drop-down dialog box. This prevents a user from adding new snap-ins to the console file or re-arranging the window. From the console menu, select Save As and give the taskpad an appropriate name such as “hhrradmin.”

NFuse/Citrix Support Servers

Preferably, Citrix NFuse is the portal for company support personnel and customer administrators to access the “Custdm10” customer domain Active Directory administrative functions across the Internet 106 or intranet 108 using only a web browser. This provides good security and accessibility for the administrative function.

As new hospitals are installed, a taskpad application is developed by the application installer(s) and a taskpad are created for the hospital organization and published on an NFuse support Terminal Server 114 for availability.

The NFuse server 114 uses Custdm10 Active Directory security to ensure that hospital administrators can manage users and groups specific to that hospital's organization and none other.

Configuring Citrix Servers for Customer Access

In order to allow customer administrators to access the Citrix servers for managing customer accounts, preferably, they should first receive permission from the ASP 121.

First click Start . . . Programs . . . Metaframe Tools, and then Citrix Connection Configuration.

Next, highlight ica-tcp connection and right click to open permissions.

Add CUSTDM10\ALL CLIENT ADMINS and check Allow User Access.

Add CUSTDM10\Client Server Support and check Allow User Access.

Close Citrix Connection Configuration.

Installing Citrix ICA Client

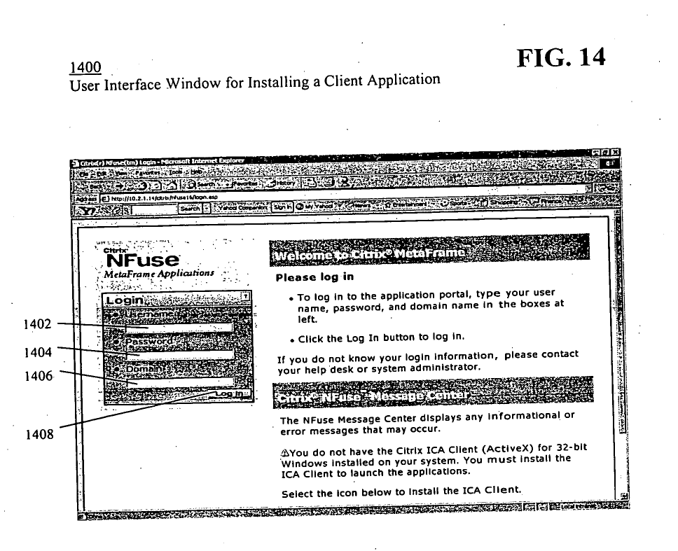

FIG. 14 illustrates a user interface window 1400 for installing a client application on the client device 102, as shown in FIG. 1, in accordance with a preferred embodiment of the present invention. A customer account administrator installs Citrix ICA Client on his/her system 102. Note that the lower right hand section of the window 1400 is entitled “Citrix Nfuse Message Center.” If the user does not have the Citrix ICA Client installed, there a warning message is presented such as: “You do not have the Citrix ICA Client (Active X) for 32-bit Windows installed on your system. Install the ICA Client to launch the application. Select the Icon below to install the client.”

Domain Name Service (DNS)

The domain name space for a company's ASP infrastructure is ASP.companymedical.com. The domain name space resides on two public DNS servers on the ASP network 121. These servers are accessible from the Internet for resolving DNS names and URL's unique to the company's application services.

For the customer account management (CAM) application, a qualifier administrator uniquely identifies the server and function for account administration. The fully qualified name is useradmin.ASP.companymedical.com/nfuse1/login.asp.

This identifier is setup on both public DNS servers (DNSSYS01 and DNSSYS02) so that any reference to the above URL on Internet or intranet points to the server RESAPPOL (64.46.195.11) . . . the NFuse server 114.

Applying Security to an Organizational Structure

Delegate Control

Control of the organization is delegated to the hhrr administration group for this hospital organization. In similar fashion to the example above, control of HH20 organization to HH20 may be delegated to an administration group. Further, a user via a user interface image (not shown) is also able to select tasks to delegate from the following tasks: Create, Delete and Manage User Accounts; Reset Passwords on User Accounts; Read All User Information; Create, Delete, and Manage Groups and Modify Membership of a Group.

Managing External Permissions

The global group ALL Client Administrators is used to grant and deny access to various resources within the network 121 and Active Directory structure. The purpose is to hide Active Directory containers and objects outside of the hospital organizational structure. This is accomplished by applying security (Deny Read/List Access) on each container outside of the customer organization. For this reason, it is important that the HH20 administration group be a member of All Client Administrators group.

The group All Client Administrators has been added to the NFUSE server permissions for the ica-tcp connection in order to enable access the NFUSE server(s) from a web browser for managing customer accounts.

There is also a global group on the “Custdm10” customer domain called Client Server Support that has the same privileges.

It is desirable that the hospital administrators cannot see users and groups from another, not affiliated, hospital within the customer organization. This security is accomplished by adding the current hospital admin group, such as hh20 administration, to each other organizational security (i.e., an access control list (ACL) in the Active Directory) and issue a deny read list access on the organization and it's child objects.

The customer account management (CAM) system 100 advantageously provides efficient and secure intranet and Internet access for customer administrators at organizations 104, such as hospitals, to manage their own application user accounts. The system 100 restrict access so that customer account administrators have no access to user accounts assigned to other organizations, preferably by adding a prefix representing the parent organization in order to establish uniqueness. The system 100 permits customers to self-sufficient to manage their own application user accounts, without requiring intervention by or cooperation with another party. The system 100 provides real time savings for customers, and requires less staff time at the ASP support help desk to perform account management functions.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system enabling individual organizations of a plurality of different organizations to manage access of employees to at least one remotely located application hosted by an application service provider, comprising:
at least one database containing data representing,
a plurality of user interface images associated with a corresponding plurality of organizations, and
a plurality of executable procedures associated with the corresponding plurality of user interface images, an executable procedure supporting a user of a particular organization in managing access of employees of the particular organization to an application hosted by an application service provider; and
a command processor employing the at least one database for initiating execution of a particular executable procedure in response to a command initiated using a particular user interface image associated with the particular executable procedure and with the particular organization, the particular executable procedure supporting the user in managing access of an employee of the particular organization to an application.

2. A system according to claim 1, including
an authorization processor for authorizing access of the user to the particular user interface image and the associated particular executable procedure in response to received identification information of the user.

3. A system according to claim 2, wherein
the authorization processor excludes access of the user and employees of the particular organization to user interface images and executable procedures and data associated with organizations other than the particular organization.

4. A system according to claim 3, wherein
the authorization processor excludes access of the user and employees of the particular organization to data associated with organizations other than the particular organization by removing permission of the user and employees of the particular organization to access the data associated with the other organizations from a directory of permissions used to control data access.

5. A system according to claim 4, wherein
the directory of permissions comprises a Microsoft compatible Active Control List (ACL).

6. A system according to claim 4, wherein
the authorization processor removes the permission of the user and employees of the particular organization in response to addition of the particular organization as a new organization to the plurality of organizations.

7. A system according to claim 1, wherein
the plurality of executable procedures comprises a plurality of sets of executable procedures associated with the corresponding plurality of user interface images and
the command processor employs the at least one database for initiating execution of a particular executable procedure in a particular set of executable procedures in response to a command initiated using the particular user interface image.

8. A system according to claim 1, wherein
an executable procedure enables the user to at least one of, (a) add an employee and (b) remove an employee, of an organization as a user entitled to access the application hosted by the application service provider.

9. A system according to claim 8, wherein
the executable procedure changes authorization information associated with the added or removed employee.

10. A system according to claim 1, wherein
an executable procedure enables the user to amend information used in authorizing a particular employee of an organization to access the application hosted by the application service provider.

11. A system according to claim 1, including
an authorization processor for authorizing access of the employee of the particular organization to the particular user interface image and the associated particular executable procedure in response to received employee identification information.

12. A system according to claim 11, wherein
the authorization processor uses a combination of an organization specific identifier and received employee identification information in providing an employee access to the application hosted by the application service provider to prevent replication of user identification information between two employees of different organizations of the plurality of organizations.

13. A system according to claim 1, wherein
an executable procedure comprises processor executable instruction in a computer language including at least one of, (a) assembly language, (b) machine code, (c) a compiled computer language, (d) an interpreted computer language, (e) a compilable computer language, (f) a script language and (g) hardware encoded logic.

14. A system according to claim 1, wherein
the particular executable procedure comprises a template procedure customized by at least one of, (a) the user and (b) a technician.

15. A system according to claim 1, wherein
at least one of, (a) the command is initiated at a user site via a particular user interface image communicated to the user site and (b) the particular executable procedure is communicated to a user site and executed at the user site.

16. A system enabling an individual organization of a plurality of different organizations to manage access of employees to at least one remotely located application hosted by an application service provider, comprising:
a communication processor for accessing at least one database containing data representing,
a plurality of user interface images associated with a corresponding plurality of organizations, and
a plurality of executable procedures associated with the corresponding plurality of user interface images, an executable procedure supporting a user of a particular organization in managing access of employees of the particular organization to an application hosted by an application service provider; and
a command processor for using the communication processor in initiating execution of a particular executable procedure in response to a command initiated at a user site using a particular user interface image communicated to the user site, the particular user interface image being associated with the particular executable procedure and with the particular organization, the particular executable procedure supporting the user in managing access of an employee of the particular organization to an application.

17. A system enabling individual organizations of a plurality of different organizations to manage access of employees to at least one remotely located application hosted by an application service provider, comprising:
at least one database containing data representing,
a plurality of user interface images associated with a corresponding plurality of organizations, and
a plurality of executable procedures associated with the corresponding plurality of user interface images, an executable procedure supporting a user of a particular organization in managing access of employees of the particular organization to an application hosted by an application service provider; and
an authorization processor for authorizing access of the user to a particular user interface image and an associated particular executable procedure associated with the particular organization in response to received identification information of the user and excluding access of the user and employees of the particular organization to user interface images and executable procedures and data associated with organizations other than the particular organization.

18. A system according to claim 17, wherein
the authorization processor authorizes access of the user in response to a command initiated-using the particular user interface image.

19. A user interface system enabling individual organizations of a plurality of different organizations to manage access of employees to at least one remotely located application hosted by an application service provider, comprising:
at least one database containing data representing,
a plurality of sets of user interface images associated with a corresponding plurality of organizations, and
a plurality of executable procedures associated with the corresponding plurality of sets of user interface images, an executable procedure supporting a user of a particular organization in managing access of employees of the particular organization to an application hosted by an application service provider; and
a command processor employing the at least one database for initiating execution of a particular executable procedure in response to a command initiated using a user interface image selected from a set of images associated with a particular organization, the particular executable procedure supporting the user in managing access of an employee of the particular organization to an application.
